(19) United States
(12) Patent Application Publication
(10) Pub. No.: US 2018/0189371 A1
(43) Pub. Date: Jul. 5, 2018

(54) UPDATING SQLITE DATABASE

(71) Applicant: Hangzhou DPtech Technologies Co., Ltd., Zhejiang Province (CN)

(72) Inventors: Zhiqing FU, Hangzhou (CN); Chunping XIE, Hangzhou (CN)

(73) Assignee: Hangzhou DPtech Technologies Co., Ltd., Zhejiang Province (CN)

(21) Appl. No.: 15/855,220

(22) Filed: Dec. 27, 2017

(30) Foreign Application Priority Data
Dec. 29, 2016 (CN) 201611247296.2

(51) Int. Cl. G06F 17/30

(52) U.S. Cl. CPC G06F 17/30575; G06F 17/30297; G06F 17/30339; G06F 17/30345

(57) ABSTRACT

A method and apparatus for updating an SQLite database are provided. According to an example of the method, if a source database includes a second data table having the same table name as a first data table in a target database, a mapping data table may be created in the source database. Further, each field in the first data table which is absent in the second data table may be determined as a new field, and the new field is created in the mapping data table. A name and a default value of the new field may be recorded if the new field is configured with a primary key constraint and the default value. In this way, the data stored in the second data table as well as the recorded name and default value of the new field may be added to the mapping data table with an insert statement.

### CROSS REFERENCE TO RELATED APPLICATIONS

This application claims priority to Chinese Patent Application No. 201611247296.2 entitled “METHOD AND APPARATUS FOR UPDATING SQLITE DATABASE” filed on Dec. 29, 2016, the entire content of which is incorporated herein by reference.

### TECHNICAL FIELD

The present disclosure relates to updating an SQLite database.

### BACKGROUND

Resource configuration information on a network device, such as a forwarding device, a security device and so on, may be stored in an SQLite database. However, during the operation of the network device, when a new function is added or a function with a problem is repaired, the resource configurations of the network device may be updated. For example, the SQLite database for storing the resource configuration information of the network device is updated. If the values of some new fields having primary key constraints in the updated SQLite database are not default values, it may lead to disordered resource configurations of the network device, thereby affecting the operation of the network device.

### SUMMARY

In view of this, the present disclosure provides a method and an apparatus for updating an SQLite database to improve the stability of updating resource configuration information of a network device.

In a first aspect, the present disclosure provides a method of updating an SQLite database, including: determining whether a source database includes a second data table having the same table name as a first data table in a target database, where the source database records current resource configuration data of a network device, and the target database records target resource configuration data to which the network device is to be updated; creating a mapping data table in the source database when the source database includes the second data table having the same table name as the first data table in the target database; determining whether each field in the first data table is a new field that is absent in the second data table; creating the new field in the mapping data table; recording a name and a default value of the new field in a case that the new field is configured with a primary key constraint and the default value; and adding data stored in the second data table as well as the recorded name and default value of the new field to the mapping data table with an insert statement.

In a second aspect, the present disclosure provides a network device, including: a processor and machine-readable storage medium. By reading and executing machine-executable instructions stored on the machine-readable storage medium and corresponding to an apparatus for updating an SQLite database, the processor is caused to: determine whether a source database includes a second data table having the same table name as a first data table in a target database, wherein the source database records current resource configuration data of a network device, and the target database records target resource configuration data to which the network device is to be updated; create a mapping data table in the source database when the source database includes the second data table having the same table name as the first data table in the target database; determine whether each field in the first data table is a new field that is absent in the second data table or not; create the new field in the mapping data table; record a name and a default value of the new field in a case that the new field is configured with a primary key constraint and the default value; and add data stored in the second data table as well as the recorded name and default value of the new field to the mapping data table with an insert statement.

On one hand, according to the method of updating an SQLite database provided in the present disclosure, in the process for updating the SQLite database, a default value of a new field with a primary key constraint is assigned to the new field with the primary key constraint in the mapping data table with an insert statement. In this way, after the SQLite database is updated, the value of the new field with the primary key constraint in the mapping data table is the default value, thereby effectively solving the problem arising from the fact that the value of the new field with the primary key constraint is not the default value after the SQLite database is updated.

On the other hand, after the database is updated, the value of the new field with the primary key constraint is the default value. In this way, the service module may directly use the configuration data corresponding to the new field with the primary key constraint without invoking additional program. Thus, the efficiency of the whole development system is effectively improved, and the error probability of programming is reduced.

### BRIEF DESCRIPTION OF DRAWINGS

FIG. 1 is a flowchart illustrating a method of updating an SQLite database according to an example of the present disclosure.

FIG. 2 is a flowchart illustrating a method of updating an SQLite database according to another example of the present disclosure.

FIG. 3 is a schematic diagram illustrating a hardware structure of a network device where an apparatus for updating an SQLite database is located according to an example of the present disclosure.

FIG. 4 is a schematic diagram illustrating functional modules of an apparatus for updating an SQLite database according to an example of the present disclosure.

### DETAILED DESCRIPTION

Exemplary embodiments will be described in detail herein with examples thereof represented in the drawings. When the following descriptions involve the drawings, like numerals in different drawings may represent like or similar elements unless stated otherwise. The implementations described in the following exemplary embodiments do not represent all implementations consistent with the present disclosure. On the contrary, they are merely examples of an apparatus and a method described in detail in the appended claims that are consistent with some aspects of the present disclosure.

The terminology used in the present disclosure is for the purpose of describing a particular example only, and is not intended to be limiting of the present disclosure. The singular forms such as “a”, ‘said”, and “the” used in the present disclosure and the appended claims are also intended to include multiple, unless the context clearly indicates otherwise. It is also understood that the term “and/or” as used herein refers to any or all possible combinations that include one or more associated recited items.

It should be appreciated that although different information may be described using the terms such as first, second, third, etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, the word “if” as used herein may be interpreted as “when” or “as” or “in response to determining”.

Resource configuration information of a network device may be stored in an SQLite database. However, during the operation of the network device, when a new function is added or a function with a problem is repaired, the resource configurations of the network device may be updated. For example, a source SQLite database (hereinafter, may also be referred to as the source database) corresponding to a current resource configuration version is updated with configuration data in a target SQLite database (hereinafter, may also be referred to as the target database) corresponding to a target resource configuration version.

When updating an SQLite database, both the source database and the target database may be scanned respectively to determine whether the source database includes a second data table having the same table name as a first data table in the target database. If yes, a mapping data table corresponding to the second data table may be created in the source database.

Next, all fields in the above first data table may be compared with the fields in the second data table. If the above first data table includes a new field that is absent in the second data table, a mapping field having the same field name as the new field may be created in the mapping data table of the source database. If the second data table includes a second field having the same field name as a first field in the first data table, and the first field may be determined as an original field, the original field may be created in the mapping data table of the source database, and the data corresponding to the original field in the second data table may be written into the original field in the mapping data table.

However, when the above new field is configured with a primary key constraint and a default value, it may be difficult to write the default value into the new field in the mapping data table of the source database. This is because, if a field without an assigned value is a primary key in a database insert statement, a value of the field will default to 1 in the SQLite database.

For example, assuming that a module for supporting a virtual system is desired to add in the network device, when updating the source database corresponding to the current resource configuration version of the network device, a new field vsys_id with a primary key constraint is added to store a corresponding virtual system identity (ID). Since a module not supporting the virtual system belongs to a public system, the value of the new field vsys_id in the corresponding configuration data is 0. Therefore, when the resource configurations of the network device are updated from not supporting the virtual system to supporting the virtual system, it is desired to set the value of the new field vsys_id in the mapping data table of the source database to 0.

However, as described above, in the SQLite database, if a field without an assigned value is a primary key in a database insert statement, the value of the field will default to 1. Then, in the above scenario, after the source database is updated, the value of the new field vsys_id in the mapping data table of the source database will be set to 1. Apparently, this may result in that the resources belonging to the public system are allocated to the virtual system with ID as 1. In this case, the public system may not use relevant configuration data correctly and the virtual system with ID as 1 may not operate normally as well.

In view of this, the above new field with the primary key constraint (for example, the field vsys_id) may be set to a common new field, so that when updating the SQLite database, a value may be assigned to the common new field in the mapping table of the source database based on the default value of the new field with the primary key constraint. Moreover, after the SQLite database is updated, the common new field may be used as a primary key by modifying a program of a corresponding service module in the network device. However, this solution can increase the program complexity of the service module of the network device, thereby reducing the readability of the program and increasing the error probability of programming.

Alternatively, a non-public data table for storing configuration data of a non-public system may be added besides a public data table corresponding to resource configuration information of the public system. The non-public data table may include not only all fields in a source data table, but also new fields including, for example, the new field with the primary key constraint. When the service module of the network device desires to use configuration data corresponding to the new field with the primary key constraint in the updated SQLite database, it may be determined to operate on the public data table or on the non-public data table based on whether the value of the new field with the primary key constraint is 0 or not. However, this solution also adds to the programming complexity of the service module of the network device.

Besides, when updating the SQLite database, the default value of the new field with a primary key constraint may be set to a non-zero value that cannot be configured by a user. For example, if a valid range of the virtual system ID is from 0 to 1023, the default value of the new field vsys_id may be set as 1024. Then, a plug-in patch program may be executed to check whether the value of the new field with the primary key constraint in the updated SQLite database is the particular value. If yes, the value of the new field with the primary key constraint may be modified into 0. However, this solution still increases the programming complexity of the service module of the network device.

To solve the above problem, the present disclosure provides a method of updating an SQLite database. In an database updating process, a new field with a primary key constraint and the corresponding default value may be recorded, and the data stored in the second data table in the source database corresponding to the current resource configuration version and the recorded name and default value of the new field with the primary key constraint may be added to a mapping data table in the source database with an insert statement.

In the database updating process, the default value of the new field with the primary key constraint may be assigned to the new field with the primary key constraint in the mapping data table with an insert statement, so that the value of the new field with the primary key constraint in the mapping data table is the default value after the database is updated, thereby effectively solving the problem arising from the fact that the value of the new field with the primary key constraint in the updated database is not the default value.

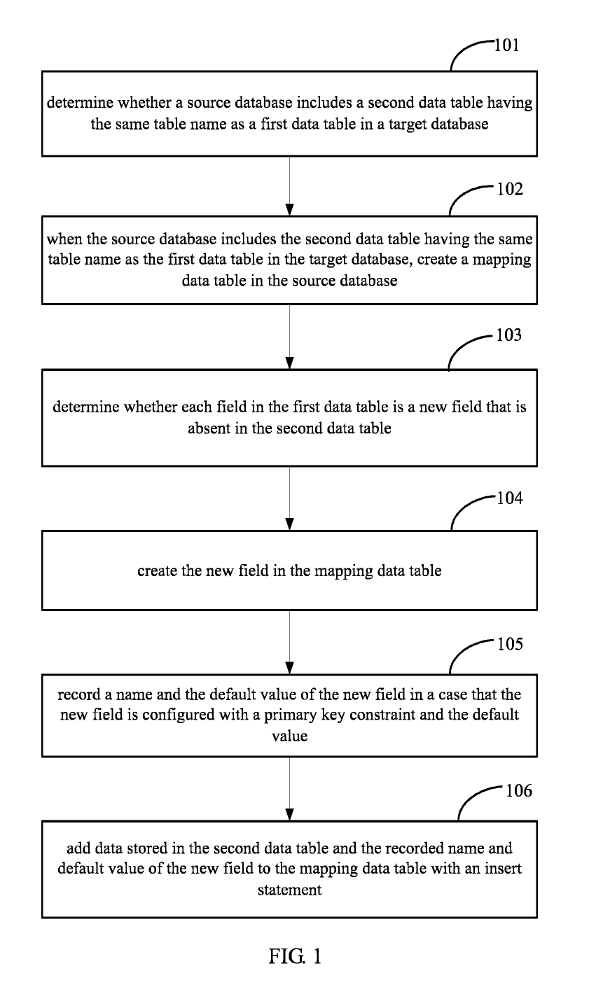

FIG. 1 is a flowchart illustrating a method of updating an SQLite database according to an example of the present disclosure. The method may be applied to a network device, including the following blocks:

At block 101, it is determined whether a source database includes a second data table having the same table name as a first data table in a target database. Where, the source database may correspond to the current resource configuration of the network device, and may be used to, for example, store the to-be-updated current resource configuration data of the network device; and the target database may correspond to the target resource configuration of the network device and may be used to, for example, store the target resource configuration data to which the network device is to be updated.

At block 102, when the source database includes the second data table having the same table name as the first data table in the target database, a mapping data table may be created in the source database.

The above network device may refer to any device that may access the Internet, including a forwarding device, a security device, and other devices that store configuration information with an SQLite database and so on.

The network device may include an operation interface via which a user can input a corresponding updating instruction to complete updating of the SQLite database.

The above source database may refer to a database corresponding to current resource configuration version of the network device. The second data table (i.e., the source data table) is stored in the source database, and a plurality of fields and the data in the fields are stored in the second data table.

The above target database may refer to a database corresponding to a target resource configuration version of the network device. The target database may include the first data table having the same table name as the second data table and a new data table relative to the source database. The first data table may include the same fields as the second data table and a new field relative to the second data table. The new data table may also contain other new fields.

The above mapping data table may refer to a data table created in the source database where the mapping data table corresponds to the second data table. When updating the SQLite database is completed, the mapping data table is the updated second data table.

In an example of the present disclosure, when the network device is to be updated from current resource configuration version to target resource configuration version, the network device may automatically generate the target database corresponding to the target resource configuration version. For example, the target database may be equivalent to a “frame”, containing at least one new field and data corresponding to the at least one new field relative to the source database. The database updating process is to update the source database to the target database by adding or deleting data tables, adding or deleting fields, inserting data, and the like.

In an example, when receiving an updating command from a user, the network device may scan the source database and the target database, and then determine whether the source database includes the second data table having the same table name as the first data table in the target database. If the source database includes the second data table having the same table name as the first data table in the target database, block 103 is executed.

At block 103, it is determined whether each field in the first data table is a new field that is absent in the second data table.

At block 104, the new field is created in the mapping data table.

At block 105, a name and the default value of the new field are recorded in a case that the new field is configured with a primary key constraint and the default value.

At block 106, data stored in the second data table and the recorded name and default value of the new field are added to the mapping data table with an insert statement.

In the SQLite database updating process, the new field with the primary key constraint and the default value may be recorded, and the data stored in the second data table and the recorded name and the default value of the new field with the primary key constraint may be added to the mapping data table with the insert statement, so that the value of the new field with the primary key constraint in the mapping data table is the default value, thereby effectively solve the problem arising from the fact that the value of the new field with the primary key constraint is not the default value.

The SQLite database updating process is to be described in detail below by taking updating the second data table to the first data table containing corresponding original data as an example.

The network device may scan the fields in the first data table and the second data table, respectively, and then determine whether the second data table includes a second field having the same name as a first field in the first data table.

If the first data table has a new field that is absent in the second data table, block 104 is executed to create the new field in the mapping data table. If the new field is configured with the primary key constraint and the default value, the name and the default value of the new field are recorded.

When comparing all the fields in the above first data table with the fields in the second data table, the data stored in the second data table and the recorded name and the default value of the new field are added to the mapping data table with an insert statement, thereby completing the updating of the second data table.

During a process of updating a SQLite database for storing the resource configuration data of the network device, the default value of the new field with the primary key constraint may be assigned to the new field with the primary key constraint in the mapping data table with an insert statement, so that the value of the new field with the primary key constraint is the default value when updating the SQLite database is completed. Thus, after updating the SQLite database is completed, a service module of the network device may directly use the configuration data corresponding to the new field with the primary key constraint, without invoking an additional program. In this way, the efficiency of the whole development system can be effectively improved, and the error probability of programming can be reduced.

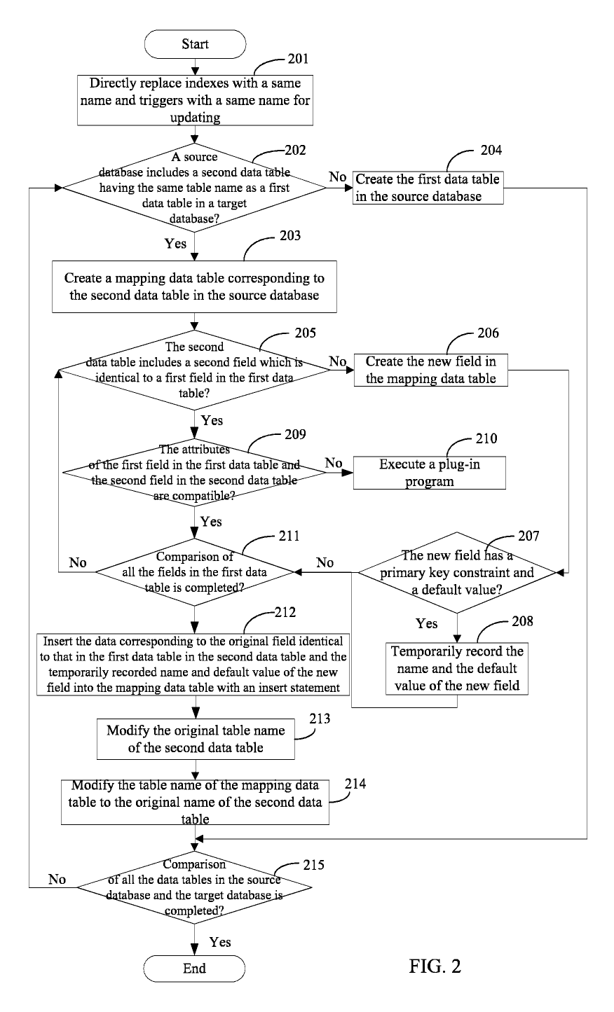

FIG. 2 is a flowchart illustrating a method of updating an SQLite database according to another example of the present disclosure. The method may be applied to a network device and may include the following blocks:

At block 201, indexes with a same name and triggers with a same name may be directly replaced for updating.

At block 202, it is determined whether a source database includes a second data table having the same table name as a first data table in a target database. If yes, block 203 is executed; otherwise, block 204 is executed.

At block 203, a mapping data table corresponding to the second data table is created in the source database.

At block 204, the first data table is created in the source database.

A user may input an updating command via an interaction interface provided by the network device. After receiving the updating command, the network device may scan the source database and the target database, and directly replace the indexes with the same name and the triggers with the same name for updating.

In the scanning process, the network device may obtain data tables from the source database and the target database, respectively, and then determine whether the source database includes the second data table having the same table name as the first data table in the target database. If the source database does not include the second data table having the same table name as the first data table in the target database, block 204 is executed to create the first data table in the source database.

If the source database includes the second data table having the same table name as the first data table in the target database, block 203 is executed to create the mapping data table corresponding to the second data table in the source database and set the table name of the mapping data table as a name different from that of the second data table. For example, the table name of the mapping data table may be set as “new+the original table name of the second data table”.

It is noted that the objective of creating the mapping data table is to update the second data table to the first data table. For example, a new field relative to the second data table and recorded in the first data table may be created in the mapping data table. If the new field has a default value, the default value may be assigned to the new field in the mapping data table. When there is an original field present in both the first data table and the second data table, data corresponding to the original field in the second data table may be added to the position of the original field in the mapping data table.

At block 205, it is determined whether the second data table includes a second field which is identical to a first field in the first data table. If yes, it indicates that the first field in the first data table is an original field, and block 209 is then executed. If no, it indicates that the first field in the first data table is a new field, and block 206 is then executed.

At block 206, the new field is created in the mapping data table.

At block 207, it is determined whether the new field has a primary key constraint and a default value or not. If yes, block 208 is then executed; otherwise, block 211 is executed.

At block 208, the name and the default value of the new field are temporarily recorded.

The network device may scan the fields in both the first data table and the second data table, respectively, and then determine whether the second data table includes a second field identical to a first field in the first data table. If the second data table includes the second field identical to the first field in the first data table, it indicates that the first field in the first data table is not a new field, and then block 209 may be executed, which will be described in detail below.

If a field in the first data table is absent in the second data table, it indicates that the field in the first data table is a new field, and block 206 may then be executed to create the new field in the mapping data table.

The network device may determine whether the new field has a primary key constraint and a default value. For example, if the new field in the first data table is neither configured with the primary key constraint nor the default value, the value of the new field in the mapping data table may be set as a system default value. If the new field is a numeric field, the value of the new field may be set to a system default value 0. If the new field is a non-numeric field, such as a character string, the value of the new field may be set to NULL.

If the new field in the first data table is configured with the default value but without the primary key constraint, the default value of the new field may be assigned to the new field in the mapping data table.

For example, for a Web access control configuration data table, a table creating statement for the second data table in the source database may be: CREATE TABLE tb_access_cfg (id INTEGER PRIMARY KEY, ip TEXT, state INTEGER).

When the resource configuration of the network device is updated, a configuration item, such as a port number, may be added to the target resource configuration as a TCP (Transmission Control Protocol) destination port number for providing Web service, and the port number may default to 80. In this case, an automatically-generated table-creating statement for the first data table in the target database may be: CREATE TABLE tb_access_cfg (id INTEGER PRIMARY KEY, ip TEXT, port INTEGER DEFAULT 80).

The new field port configured with the default value 80 but without a primary key constraint may be obtained by scanning the two table-creating statements. Moreover, after the new field port is created in the above mapping data table, the value 80 may be assigned to the new field port in the mapping data table.

If the new field in the first data table has a primary key constraint and a default value, the name and the default value of the new field may be recorded.

A Web access control configuration data table is still taken for example. Assuming that the current resource configuration version of the network device does not support a virtual system, and the to-be-updated target resource configuration version supports the virtual system and is configured with a Web service destination port number, an automatically-generated table-creating statement for the first data table in the target database may be: CREATE TABLE tb_access_cfg (vsys_id INTEGER DEFAULT 0, id INTEGER, ip TEXT, port INTEGER DEFAULT 80, PRIMARY KEY(vsys_id, id)).

In this case, the new field vsys_id with the primary key constraint and the default value 0 thereof may be recorded.

At block 209, it is determined whether the attributes of the first field in the first data table and the second field in the second data table are compatible. If no, block 210 is executed; and if yes, block 211 is executed.

At block 210, if the above attributes are not compatiable, the updating may be implemented by executing a plug-in program.

At block 211, if the above attributes are compatible, it is determined whether comparison of all the fields in the first data table is completed. If the comparison of all the fields in the first data table is completed, it indicates that the fields in the first data table have been processed, and block 212 may then be executed. If the comparison of all the fields in the first data table is not completed, it indicates that there are still unprocessed fields in the first data table, and block 205 is thus repeated to continuously process a next field in the first data table.

At block 212, the data corresponding to the original field identical to that in the first data table in the second data table and the temporarily recorded name and default value of the new field may be inserted into the mapping data table with an insert statement.

If the second data table includes a second field identical to a first field in the first data table, the first field may be determined as an original field. Then, the original field may be created in the mapping data table and block 209 may be then executed to determine whether the attributes of the first field in the first data table and the second field in the second data table are compatible, where the compatibility of attributes may mean that a capacity of a character string increases, a capacity of a integer value increases, and/or an integer value is updated to a character string.

If the attributes of the first field in the first data table and the second field in the second data table are not compatible, it indicates that the data corresponding to the original field (the second field) in the second data table cannot be inserted into the original field in the mapping data table. In this case, a user may complete upgrading by executing a plug-in patch program.

If the attributes of the first field in the first data table and the original field (the second field) in the second data table are compatible, the data corresponding to the second field in the second data table may be inserted into the original field in the mapping data table.

It may be then determined whether comparison of all the fields in the first data table is completed, and if no, the above blocks 205 to 211 may be repeated until the comparison of all the fields in the first data table is completed.

If the comparison of all the fields in the first data table is completed, the data corresponding to the original field (the second field) in the second data table, where the original field in the second data table is identical to the first field in the first data table, and the temporarily recorded name and default value of the new field may be inserted into the mapping data table with an insert statement.

The Web access control configuration data table is still taken for example. It is assumed that the current resource configuration version of the network device does not support a virtual system, and the to-be-updated target resource configuration version supports the virtual system and is configured with a Web service destination port number. For example, when updating a SQLite database for storing the resource configuration data of the network device, an insert statement for inserting data corresponding to an original field and a name and a default value of a new field with a primary key constraint into the mapping data table may be shown as below: INESRT INTO tb_access_cfg (vsys_id, id, ip) VALUES(0, <id-value>, <ip-value>);

Where <id-value> and <ip-value> are original fields, and vsys_id is the new field with the primary key constraint.

At block 213, the original table name of the second data table is modified.

At block 214, the table name of the mapping data table is modified to the original name of the second data table.

At block 215, it is determined whether comparison of all the data tables in the source database and the target database is completed. If yes, the process for updating SQLite database ends. If no, block 202 is repeated to continuously process a next data table in the target database.

After the data corresponding to the original field in the second data table and the name and default value of the new field with the primary key constraint are inserted into the above mapping data table, the original table name of the second data table in the source database may be modified to, for example, “old +the original table name of the second data table”. Moreover, the table name of the mapping data table may be modified to the original table name of the second data table, thereby completing the process for updating the second data table.

For example, assuming that the original table name of the second data table is “tb_access_cfg”, the current table name of the second data table may be modified to “old+tb_access_cfg”, and the table name of the mapping data table may be modified to “tb_access_cfg”.

It may be determined whether the comparison of all the data tables in the source database and the target database is completed. If no, blocks 202 to 215 may be repeated until the comparison of all the data tables is completed, thereby completing the process for updating all the data tables in the source database.

The present disclosure provides a method of updating an SQLite database. In an updating process, a new field with a primary key constraint and a default value thereof may be recorded, and the data stored in the second data table and the recorded name and default value of the new field with the primary key constraint may be added to the mapping data table with an insert statement.

On one hand, according to the method of updating an SQLite database provided in the present disclosure, in the process for updating the SQLite database, a default value of a new field with a primary key constraint is assigned to the new field with the primary key constraint in the mapping data table with an insert statement. In this way, after the SQLite database is updated, the value of the new field with the primary key constraint in the mapping data table is the default value, thereby effectively solving the problem arising from the fact that the value of the new field with the primary key constraint is not the default value after the SQLite database is updated.

On the other hand, after the database is updated, the value of the new field with the primary key constraint is the default value. In this way, the service module may directly use the configuration data corresponding to the new field with the primary key constraint without invoking additional program. Thus, the efficiency of the whole development system is effectively improved, and the error probability of programming is reduced.

Corresponding to the examples of the method of updating an SQLite database as described above, the present disclosure also provides examples of an apparatus for updating an SQLite database.

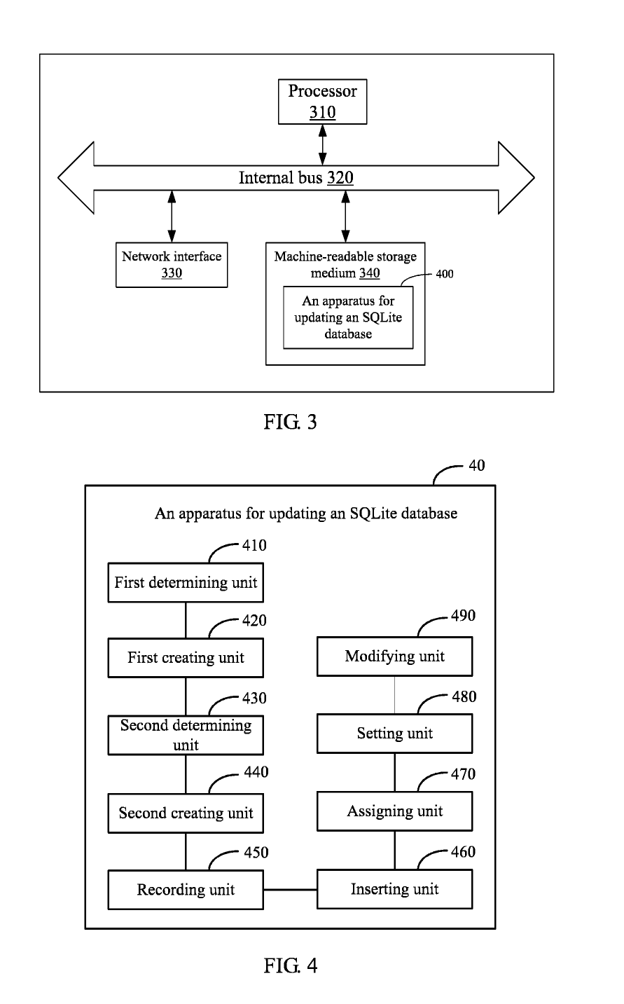

In an example, the apparatus for updating an SQLite database in the present disclosure may be applied to a network device. The example of the apparatus may be implemented by software, and may also be implemented by hardware or a combination thereof. Taking software implementation for example, the apparatus, as a logical apparatus, may be understood as machine-executable instructions stored on a machine-readable storage medium. From the hardware level, FIG. 3 is a schematic diagram illustrating a hardware structure of a network device where an apparatus for updating an SQLite database is located according to an example of the present disclosure. In addition to a processor 310, an internal bus 320, a network interface 330 and a machine-readable storage medium 340 shown in FIG. 3, the network device where the apparatus 400 is located in an example may include other hardware according to actual functions of the apparatus for updating an SQLite database, which will not be redundantly described herein.

FIG. 4 is a schematic diagram illustrating functional modules of an apparatus for updating an SQLite database according to an example of the present disclosure. The apparatus may include:

a first determining unit 410 configured to determine whether a source database includes a second data table having the same table name as a first data table in a target database, wherein the source database records current resource configuration data of a network device, and the target database records target resource configuration data to which the network device is to be updated;

a first creating unit 420 configured to create a mapping data table in the source database when the source database includes the second data table having the same table name as the first data table in the target database;

a second determining unit 430 configured to determine whether each field in the first data table is a new field that is absent in the second data table or not;

a second creating unit 440 configured to create the new field in the mapping data table;

a recording unit 450 configured to record a name and a default value of the new field in a case that the new field is configured with a primary key constraint and the default value; and

an inserting unit 460 configured to add data stored in the second data table as well as the recorded name and default value of the new field to the mapping data table with an insert statement.

In an example, the apparatus may also include an assigning unit 470 configured to when the new field is configured with the primary key constraint but without the default value, set a value for the new field based on the primary key constraint in the mapping data table.

In an example, the apparatus may also include a setting unit 480 configured to when the new field is configured with the default value but without the primary key constraint, set the value of the new field to the default value in the mapping data table; and when the new field is neither configured with the primary key constraint nor the default value, set the value of the new field to a system default value in the mapping data table.

In an example, the creating unit 420 may also be configured to when the source database does not include the second data table having the same table name as the first data table in the target database, create the first data table in the source database.

In an example, the apparatus may also include a modifying unit 490 which is configured to when the data stored in the second data table as well as the name and the default value of the new field are added to the mapping data table with the insert statement, modify a table name of the mapping data table to the table name of the second data table.

Details of the implementation process of the functions and effects of different units in the above apparatus may be seen from the implementation process of corresponding blocks in the above method, which will not be redundantly described herein.

Since the embodiments of the apparatus substantially correspond to the method embodiments, a reference may be made to part of the descriptions of the method embodiments for the related part. The embodiments of the apparatus described above are merely illustrative, where the units described as separate members may be or not be physically separated, and the members displayed as units may be or not be physical units, i.e., may be located in one place, or may be distributed to a plurality of network units. Part or all of the modules may be selected according to actual requirements to implement the objectives of the solutions in the embodiments. Those of ordinary skill in the art may understand and carry out them without creative work.

In different examples, the machine-readable storage medium 340 may be: a Read-Only Memory (ROM), a volatile memory, a nonvolatile memory, a flash memory, a storage drive (e.g. hard disk drive), a solid state harddisk, any type of storage disk (e.g., optical disk, Digital Video Disk (DVD)), or a similar storage medium, or a combination thereof.

The example below is implemented with software, which describes how the network device runs machine-executable instructions. In this example, the apparatus for updating the SQLite database should be understood as machine-executable instructions stored on the machine-readable storage medium 340. When the processor 310 of the network device executes machine-executable instructions corresponding to the apparatus for updating the SQLite database, by reading and executing machine-executable instructions stored on the machine-readable storage medium 340 and corresponding to the apparatus for updating the SQLite database, the processor 310 is caused to perform the above method of updating an SQLite database.

According to an example of the present disclosure, there is also provided a machine-readable storage medium containing machine-executable instructions, for example, the machine-readable storage medium 340 in FIG. 3. The machine-executable instructions may be executed by a processor 310 of a network device to implement the above method of updating an SQLite database.

The foregoing disclosure is merely illustrative of preferred embodiments of the disclosure but not intended to limit the disclosure, and any modifications, equivalent substitutions, adaptations thereof made without departing from the spirit and scope of the disclosure shall be encompassed in the claimed scope of the appended claims.

1. A method of updating an SQLite database, comprising:
determining whether a source database includes a second data table having the same table name as a first data table in a target database, wherein the source database records current resource configuration data of a network device, and the target database records target resource configuration data to which the network device is to be updated;
creating a mapping data table in the source database when the source database includes the second data table having the same table name as the first data table in the target database;
determining whether each field in the first data table is a new field that is absent in the second data table or not;
creating the new field in the mapping data table;
recording a name and a default value of the new field in a case that the new field is configured with a primary key constraint and the default value; and
adding data stored in the second data table as well as the recorded name and default value of the new field to the mapping data table with an insert statement.

2. The method of claim 1, further comprising:
when the new field is configured with the primary key constraint but without the default value, setting a value for the new field based on the primary key constraint in the mapping data table.

3. The method of claim 1, further comprising:
when the new field is configured with the default value but without the primary key constraint, setting the value of the new field to the default value in the mapping data table; and
when the new field is neither configured with the primary key constraint nor the default value, setting the value of the new field to a system default value in the mapping data table.

4. The method of claim 1, further comprising:
when the source database does not include the second data table having the same table name as the first data table in the target database, creating the first data table in the source database.

5. The method of claim 1, further comprising:
when the data stored in the second data table as well as the name and the default value of the new field are added to the mapping data table with the insert statement, modifying a table name of the mapping data table to the table name of the second data table.

6. A network device, comprising:
a processor; and
machine-readable storage medium;
wherein by reading and executing machine-executable instructions stored on the machine-readable storage medium and corresponding to an apparatus for updating an SQLite database, the processor is caused to:
determine whether a source database includes a second data table having the same table name as a first data table in a target database, wherein the source database records current resource configuration data of a network device, and the target database records target resource configuration data to which the network device is to be updated;
create a mapping data table in the source database when the source database includes the second data table having the same table name as the first data table in the target database;
determine whether each field in the first data table is a new field that is absent in the second data table or not;
create the new field in the mapping data table;
record a name and a default value of the new field in a case that the new field is configured with a primary key constraint and the default value; and
add data stored in the second data table as well as the recorded name and default value of the new field to the mapping data table with an insert statement.

7. The device of claim 6, wherein, the processor is further caused by the machine-executable instructions to:
when the new field is configured with the primary key constraint but without the default value, set a value for the new field based on the primary key constraint in the mapping data table.

8. The device of claim 6, wherein, the processor is further caused by the machine-executable instructions to:
when the new field is configured with the default value but without the primary key constraint, set the value of the new field to the default value in the mapping data table; and
when the new field is neither configured with the primary key constraint nor the default value, set the value of the new field to a system default value in the mapping data table.

9. The device of claim 6, wherein, the processor is further caused by the machine-executable instructions to:
when the source database does not include the second data table having the same table name as the first data table in the target database, create the first data table in the source database.

10. The device of claim 6, wherein, the processor is further caused by the machine-executable instructions to:
when the data stored in the second data table as well as the name and the default value of the new field are added to the mapping data table with the insert statement, modify a table name of the mapping data table to the table name of the second data table.
